(19) United States
(12) Patent Application Publication
(10) Pub. No.: US 2011/0125464 A1
(43) Pub. Date: May 26, 2011

(54) APPARATUS, METHOD, AND PROGRAM FOR OPTIMIZATION MODEL ANALYSIS

(75) Inventors: Takanori IDE, Chiryu (JP); Hiroyuki KITAJIMA, Anjo (JP); Iku KOSAKA, Novi, MI (US)

(73) Assignees: AISIN AW CO., LTD., ANJO-SHI (JP); VANDERPLAATS R D INC., NOVI, MI (US)

(21) Appl. No.: 12/950,502

(22) Filed: Nov. 19, 2010

(30) Foreign Application Priority Data
Nov. 24, 2009 (JP) 2009-266726

(51) Int. Cl. G06F 17/50

(52) U.S. Cl. 703/1

(57) ABSTRACT

An optimization model analysis apparatus configured with a finite element model generation unit that generates on the basis of a structural configuration of a design model having a 3D shape a finite element model for analyzing acoustic characteristics of the design by a finite element method. The apparatus is configured with a shell model generation unit that generates a model by dividing a surface of the finite element model into a plurality of plate elements having a polygonal shape; an optimization model generation unit that superimposes the shell model on the surface of the finite element model to generate an optimization model; and an optimization model modification unit that displaces nodal points which serve as vertexes of the plate elements in a direction intersecting a plane of the plate elements by displacing at least one of the nodal points in a direction of reducing a thickness of the optimization model.

### INCORPORATION BY REFERENCE

The disclosure of Japanese Patent Application No. 2009-266726 filed on Nov. 24, 2009 including the specification, drawings and abstract is incorporated herein by reference in its entirety.

### BACKGROUND OF THE INVENTION

The present invention relates to an apparatus, a method, and a program for optimization model analysis that are used to determine through analysis an optimum structural configuration of a design model.

### DESCRIPTION OF THE RELATED ART

In the related art, in determining through analysis an optimum structural configuration of a design model to optimize the acoustic characteristics, for example, of the design model, the structural characteristics and the acoustic characteristics of the design model are first individually analyzed on a computer through numerical simulation that uses a numerical analysis program. Then, a designer takes the analysis results into comprehensive consideration to specify a structural portion that is effective for improving the acoustic characteristics. Subsequently, the designer prepares a modified model by modifying, for example reinforcing, the specified structural portion, and thereafter analyzes the structural characteristics and the acoustic characteristics of the prepared modified model on the computer to specify a structural portion of the modified model to be reinforced again. Thereafter, the designer iteratively performs this cycle of processes to derive an optimum structural configuration of the design model.

In the case where a complicated design model is to be analyzed using the above method, however, the analysis results of the structural characteristics and the acoustic characteristics of the design model output from the computer may be so intricate as to impose excessive intellectual work on the designer. Accordingly, in an acoustic structure optimum design analysis system disclosed in Japanese Patent Application Publication No. JP-A-2007-188164, the structural characteristics and the acoustic characteristics of a design model are individually analyzed, and thereafter the analysis results are used to automatically derive on a computer an optimum structural configuration of the design model with an indication of a structural portion of the design model to be modified in order to optimize the acoustic characteristics of the design model.

### SUMMARY OF THE INVENTION

In the acoustic structure optimum design analysis system disclosed in JP-A-2007-188164, reinforcing shell elements are set as reinforcing phase members in a design subject region of the design model. Then, the acoustic characteristics of the design model are optimized while changing the respective element thicknesses of the reinforcing shell elements as design variables. In this case, the respective element thicknesses of the reinforcing shell elements are varied in the range of positive values. Therefore, the thickness of the design model after setting the reinforcing shell elements is increased compared to that before setting the reinforcing shell elements. That is, in optimizing the acoustic characteristics of a design model using the acoustic structure optimum design analysis system, the weight of the design model is inevitably increased.

The present invention has been made in view of the foregoing circumstances, and it is therefore an object of the present invention to provide an apparatus, a method, and a program for optimization model analysis that can determine through analysis an optimum structural configuration of a design model while suppressing an increase in weight of the design model.

In order to achieve the foregoing object, the present invention provides an optimization model analysis apparatus including: a finite element model generation unit that generates on the basis of a structural configuration of a design model having a three-dimensional shape a finite element model for analyzing acoustic characteristics of the design model by a finite element method; a shell model generation unit that generates a shell model by dividing a surface of the finite element model into a plurality of plate elements having a polygonal shape; an optimization model generation unit that superimposes the shell model on the surface of the finite element model to generate an optimization model; and an optimization model modification unit that displaces nodal points which serve as vertexes of the plate elements in a direction intersecting a plane of the plate elements by displacing at least one of the nodal points in a direction of reducing a thickness of the optimization model.

According to the above configuration, the weight of the optimization model is reduced in the case where the nodal points of the plate elements are displaced in a direction of reducing the thickness of the optimization model. Thus, it is possible to determine through analysis an optimum structural configuration of the design model while suppressing an increase in weight of the design model by displacing at least one of the nodal points which serve as the vertexes of the plate elements in a direction of reducing the thickness of the optimization model.

In the optimization model analysis apparatus according to the present invention, the optimization model modification unit may cause no displacement of a nodal point, of the nodal points, which is positioned on an outer edge defining a contour shape of the shell model.

According to the above configuration, of the nodal points of the shell model, nodal points positioned on the outer edge defining the contour shape of the shell model are excluded from design variables. Therefore, the processing load imposed on a computer in optimizing the design model is reduced, which makes it possible to determine through analysis an optimum structural configuration of the design model quickly and easily.

The optimization model analysis apparatus according to the present invention may further include a determination unit that determines whether or not a weight of the optimization model in which the nodal points have been displaced by the optimization model modification unit has been optimized, and the optimization model modification unit may displace the nodal points in a direction of reducing the weight of the optimization model in the case where a result of determination performed by the determination unit is negative.

According to the above configuration, the optimization model modification unit can recursively execute optimization of the weight of the optimization model until a structural configuration of the design model with an optimized weight is obtained.

The present invention also provides an optimization model analysis method including the steps of: generating on the basis of a structural configuration of a design model having a three-dimensional shape a finite element model for analyzing acoustic characteristics of the design model by a finite element method; generating a shell model by dividing a surface of the finite element model into a plurality of plate elements; superimposing the shell model on the surface of the finite element model to generate an optimization model; and displacing nodal points which serve as vertexes of the plate elements in a direction intersecting a plane of the plate elements by displacing at least one of the nodal points in a direction of reducing a thickness of the optimization model. According to the above configuration, the same effect as that of the above optimization model analysis apparatus can be obtained.

The present invention further provides an optimization model analysis program that causes an optimization model analysis apparatus to operate, the apparatus including a control unit that controls procedures of a process for optimizing a design model having a three-dimensional shape, the program causing the control unit to function as: a finite element model generation unit that generates on the basis of a structural configuration of the design model a finite element model for analyzing acoustic characteristics of the design model by a finite element method; a shell model generation unit that generates a shell model by dividing a surface of the finite element model into a plurality of plate elements; an optimization model generation unit that superimposes the shell model on the surface of the finite element model to generate an optimization model; and an optimization model modification unit that displaces nodal points which serve as vertexes of the plate elements in a direction intersecting a plane of the plate elements by displacing at least one of the nodal points in a direction of reducing a thickness of the optimization model. According to the above configuration, the same effect as those of the optimization model analysis apparatus and the above optimization model analysis method can be obtained.

### BRIEF DESCRIPTION OF THE DRAWINGS

FIG. 1 is a block diagram showing a computer system according to an embodiment of the present invention;

FIG. 2 is a flowchart showing a weight optimization process routine of an analysis program;

FIG. 3 is a perspective view showing a finite element model according to the embodiment of the present invention;

FIG. 4 is a perspective view showing a boundary element model according to the embodiment of the present invention;

FIG. 5 is a perspective view showing a shell model according to the embodiment of the present invention;

FIG. 6 is a perspective view showing an optimization model and a shape modified model according to the embodiment of the present invention; and

FIG. 7 is a graph showing the correlation between the sound pressure transmitted from the optimization model to an observation point and the frequency.

### DETAILED DESCRIPTION OF THE EMBODIMENTS

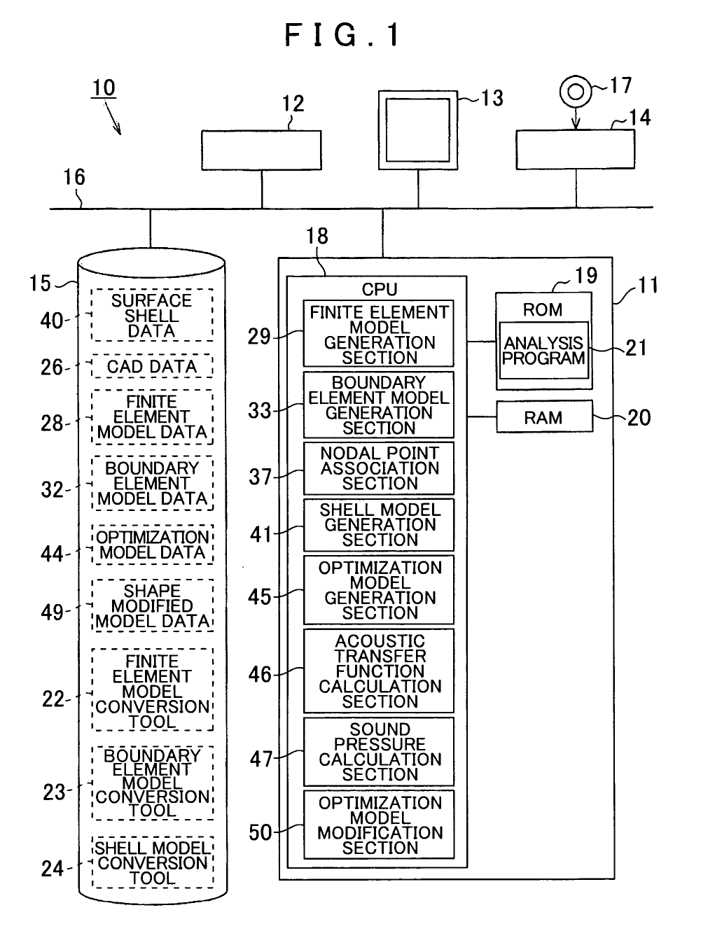

An embodiment of the present invention will be described below with reference to FIGS. 1 to 7.

As shown in FIG. 1, a computer system 10 according to the embodiment includes a control device 11, an input device 12, an output device 13, a reader device 14, and a disk device 15. In the computer system 10, the respective devices 11 to 15 are connected via a bus 16 to enable transfer of information between each other. The devices 11 to 15 are thus configured to serve as an optimization model analysis apparatus that can perform various information processes.

A storage medium 17 such as a CD (Compact Disc) is insertable into and removable from the reader device 14. In the embodiment, a storage medium 17 storing CAD data on the structural configuration of a design model to be analyzed, a storage medium 17 storing finite element model conversion software for use to convert the CAD data into a finite element model, a storage medium 17 storing boundary element model conversion software for use to convert the finite element model into a boundary element model, and a storage medium 17 storing shell model conversion software for use to convert a surface of the finite element model into a large number of plate elements to obtain a shell model are selectively inserted into and removed from the reader device 14.

The control device 11 functions as a control unit that controls the operating state of the computer system 10. The specific configuration of the control device 11 will be discussed later. The input device 12 includes a keyboard, a mouse, or the like, and is used to manually input various information. The output device 13 includes a CRT display or the like that can output the content of various information input via the input device 12 for display. The reader device 14 reads various data such as program data stored in the storage medium 17 when the storage medium 17 such as a CD is inserted into the reader device 14. The disk device 15 stores the various data read through the reader device 14.

As shown in FIG. 1, the control device 11 is configured as a digital computer including an interface (not shown) that mediates exchange of information with an external device, a CPU 18 that serves as a central processing unit, a ROM 19 that stores predetermined information in a readable form, and a RAM 20 that stores various information in a rewritable/readable form. The CPU 18 performs various logical operations necessary to analyze the structural configuration of a design model with an optimized weight when various information is input via the interface. At the same time, the CPU 18 reads and writes various information used in the logical operations. As a result, the control device 11 can function as a digital computer. The ROM 19 stores an analysis program 21 to be used by the CPU 18 to control the operating state of the entire computer system 10 in analyzing the structural configuration of a design model with an optimized weight. The RAM 20 appropriately stores the content of various information used and rewritten in the logical operations performed by the CPU 18 during operation of the computer system 10.

When a storage medium 17 storing any of the various model conversion software described above is inserted into the reader device 14, the CPU 18 causes the reader device 14 to read the data content of the model conversion software stored in the storage medium 17. The CPU 18 also causes the disk device 15 to store the read content as a corresponding one of a finite element model conversion tool 22, a boundary element model conversion tool 23, and a shell model conversion tool 24.

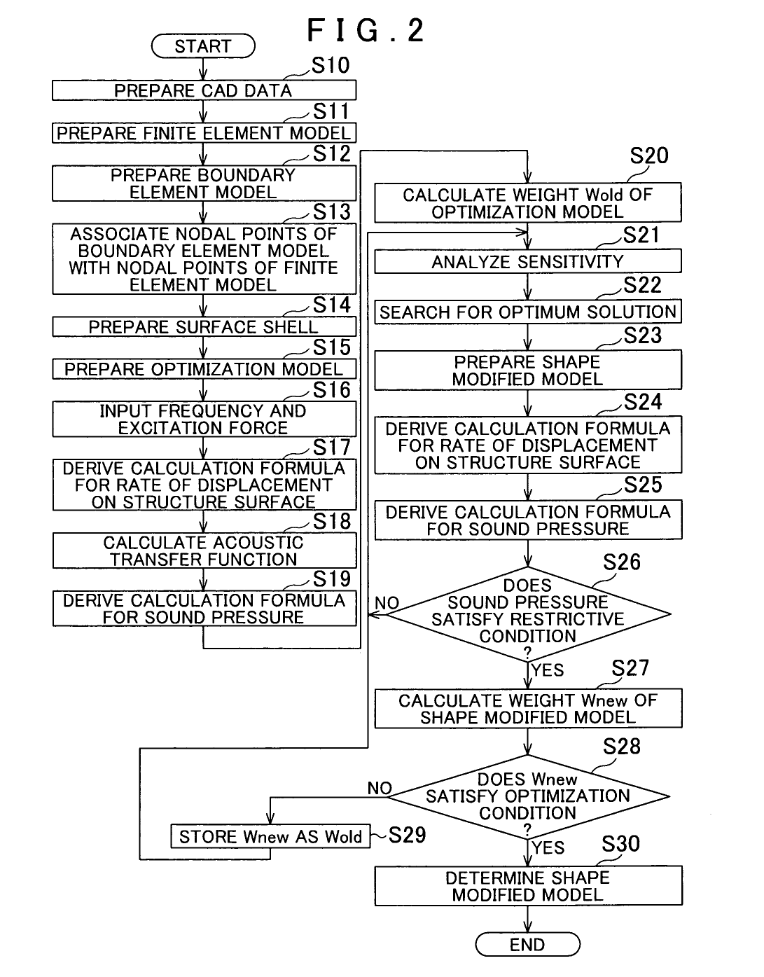

Next, a weight optimization process routine executed by the control device 11 according to the embodiment when the analysis program 21 is started will be described with reference to FIG. 2, using a transfer case 25 for an automatic transmission to be mounted on a vehicle as a subject to be analyzed (that is, a design model).

First, when a storage medium 17 storing CAD data 26 representing the three-dimensional shape of the transfer case 25 is inserted into the reader device 14, the control device 11 causes the disk device 15 to store the CAD data 26 stored in the storage medium 17 (step S10).

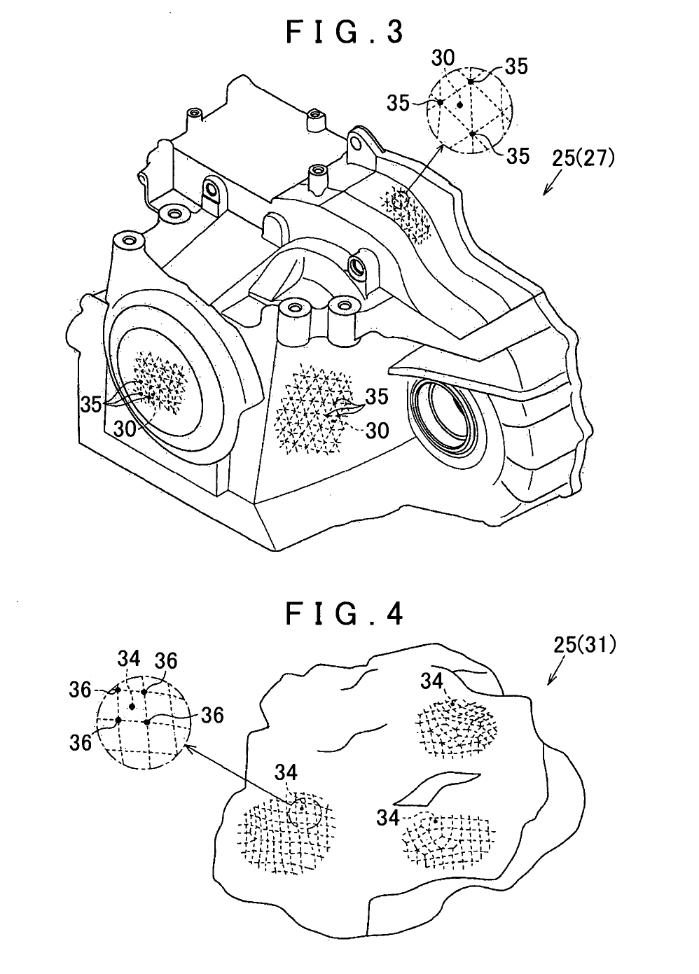

Then, as a finite element model generation step, the control device 11 starts the finite element model conversion tool 22 stored in the disk device 15. The control device 11 then converts the CAD data 26 stored in the disk device 15 into specifications data 28 on a finite element model 27 (see FIG. 3), and causes the disk device 15 to store the specifications data 28 on the finite element model 27 obtained as a result of the conversion (step S11). In this respect, the control device 11 may be considered to include a finite element model generation section 29 which serves as a finite element model generation unit that generates a finite element model 27 for analyzing the acoustic characteristics of the transfer case 25 by a finite element method. In FIG. 3, for convenience of understanding the description herein, only a part of a large number of element regions 30 forming the finite element model 27 are shown as enlarged in an exaggerated manner.

Subsequently, the control device 11 starts the boundary element model conversion tool 23 stored in the disk device 15. The control device 11 then converts the specifications data 28 on the finite element model 27 stored in the disk device 15 into specifications data 32 on a boundary element model 31 (see FIG. 4), and causes the disk device 15 to store the specifications data 32 on the boundary element model 31 obtained as a result of the conversion (step S12). In this respect, the control device 11 may be considered to include a boundary element model generation section 33 that generates a boundary element model 31 for analyzing the acoustic characteristics of the transfer case 25 by a boundary element method. In FIG. 4, for convenience of understanding the description herein, only a part of a large number of element regions 34 forming the boundary element model 31 are shown as enlarged in an exaggerated manner.

Then, the control device 11 correlates nodal points 35 (see FIG. 3) set to the vertexes of the element regions 30 having a triangular shape on the surface of the finite element model 27 generated in step S11 with nodal points 36 (see FIG. 4) set to the vertexes of the element regions 34 having a quadrangular shape on the surface of the boundary element model 31 generated in step S12 (step S13). Specifically, the control device 11 reads out from the disk device 15 each of the specifications data 28 on the finite element model 27 generated in step S11 and the specifications data 32 on the boundary element model 31 generated in step S12. The control device 11 then outputs the read models 27 and 31 to the output device 13 for display, and superimposes the models 27 and 31 on each other on the screen of the output device 13. Thereafter, the control device 11 extracts a plurality of (in the embodiment, three) nodal points 35 of the finite element model 27 that are the most proximate to each of a plurality of (in the embodiment, four) nodal points 36 set on the boundary element model 31. Then, a weighted average of the rate at each nodal point 35 of the finite element model 27 is calculated in accordance with the distances between a nodal point 36 of the boundary element model 31 and nodal points 35 of the finite element model 27 that are proximate to the nodal point 36 as indicated by Formula 1 below. As a result, the rate at each nodal point 36 of the boundary element model 31 is calculated. In this respect, the control device 11 may be considered to include a nodal point association section 37 that correlates a plurality of nodal points 36 set between the plurality of element regions 34 forming the boundary element model 31 with a plurality of nodal points 35 set between the plurality of element regions 30 forming the finite element model 27.

$${v}_{BGi} = {α}_{i 1} {v}_{{FG}_{i 1}} + {α}_{i 2} {v}_{{FG}_{i 2}} + {α}_{i 3} {v}_{{FG}_{i 3}} \\ {v}_{{BG}_{i}} ( i = 1 , … , N ) \text{:} Rate at each nodal point of the boundary element model ( N is the number of nodal points of the boundary element model ) \\ {v}_{{FG}_{ij}} ( j = 1 , 2 , 3 ) \text{:} Rate at each nodal point of the finite element model \\ {α}_{ij} ( j = 1 , 2 , 3 ) \text{:} Weighting coefficient which satisfies \cdot {\sum }_{i = 1}^{3} {α}_{i} = 1 \qquad [ Formula 1 ]$$

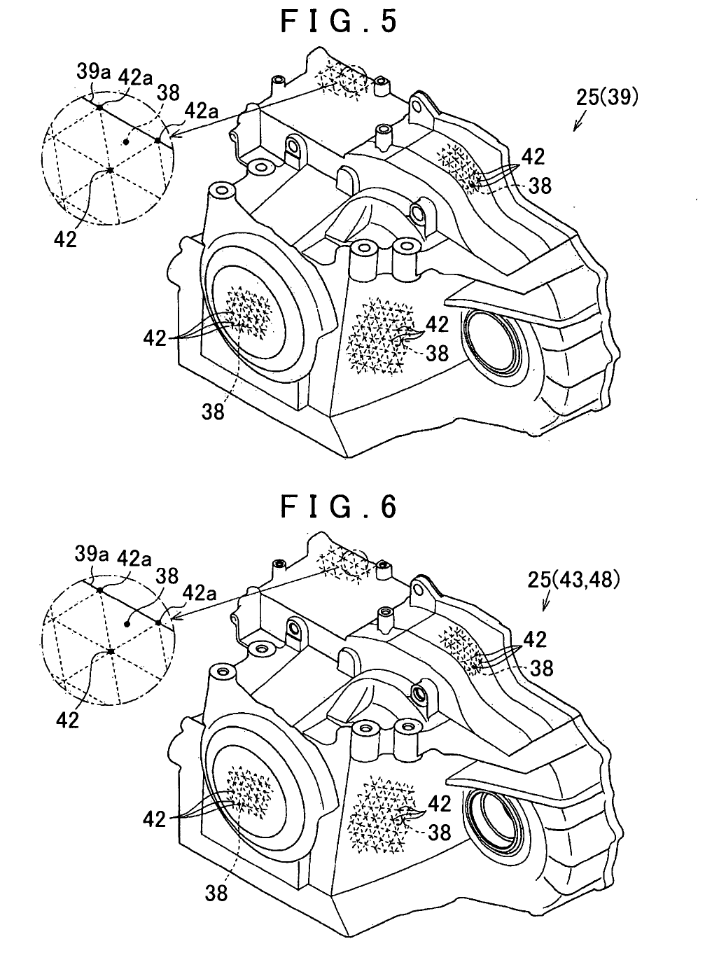

Subsequently, as a shell model generation step, the control device 11 starts the shell model conversion tool 24 stored in the disk device 15. The control device 11 then generates a shell model 39 (see FIG. 5) by dividing the surface of the finite element model 27 stored in the disk device 15 into a large number of plate elements 38 having a triangular shape, and causes the disk device 15 to store specifications data 40 on the generated shell model 39 (step S14). In this respect, the control device 11 may be considered to include a shell model generation section 41 which serves as a shell model generation unit that generates a shell model 39 of the transfer case 25. In FIG. 5, for convenience of understanding the description herein, only a part of the large number of plate elements 38 forming the shell model 39 are shown as enlarged in an exaggerated manner.

Then, as an optimization model generation step, the control device 11 reads out from the disk device 15 each of the specifications data 28 on the finite element model 27 generated in step S11 and the specifications data 40 on the shell model 39 generated in step S14. The control device 11 then outputs the models 27 and 39 to the output device 13 for display, and superimposes the shell model 39 on the surface of the finite element model 27 on the screen of the output device 13. As a result, the control device 11 generates an optimization model 43 (see FIG. 6) in which nodal points 42 set to the vertexes of the plate elements 38 of the shell model 39 are set to be displaceable in a direction orthogonal to the plane of the plate elements 38. Thereafter, the control device 11 causes the disk device 15 to store specifications data 44 on the generated optimization model 43 (step S15). In this respect, the control device 11 may be considered to include an optimization model generation section 45 which serves as an optimization model generation unit that generates an optimization model 43 of the transfer case 25. The plate elements 38 of the shell model 39 are identical in shape to the element regions 30 positioned on the surface of the finite element model 27. Therefore, in the case where the shell model 39 is superimposed on the surface of the finite element model 27, the nodal points 42 of the shell model 39 are disposed to be superimposed on the nodal points 35 of the finite element model 27.

Subsequently, the control device 11 outputs a setup screen for setting various conditions about the optimization model 43 generated in step S15 to the input device 12 for display. Then, an operator sets an excitation force to be applied to each nodal point 42 of the shell model 39 disposed on the surface of the optimization model 43 on the screen of the input device 12. At the same time, the operator sets on the screen of the input device 12 an observation point (not shown), at which the sound pressure transmitted from the optimization model 43 is observed in optimizing the weight of the optimization model 43, at a predetermined position outside the optimization model 43. Thereafter, the operator sets a frequency band of the sound pressure to be analyzed (step S16), of sound pressures observed at the set observation point.

Then, the control device 11 reads out from the disk device 15 the specifications data 44 on the optimization model 43 generated in step S15. The control device 11 then calculates the rate of displacement at which each nodal point 42 of the shell model 39 positioned on the surface of the read optimization model 43 is displaced in accordance with the excitation force set in step S16 (step S17).

Subsequently, the control device 11 reads out from the disk device 15 the specifications data 32 on the boundary element model 31 generated in step S12. The control device 11 then calculates an acoustic transfer function on the basis of the relative positional relationship between each nodal point 36 set on the read boundary element model 31 and the observation point for the sound pressure set in step S16 (step S18).

The acoustic transfer function correlates the rate of displacement of each nodal point 36 of the boundary element model 31 with the sound pressure transmitted from the boundary element model 31 to the observation point in accordance with the displacement of that nodal point 36. In this respect, the control device 11 may be considered to include an acoustic transfer function calculation section 46 that calculates an acoustic transfer function that correlates each nodal point 36 of the boundary element model 31 with the sound pressure transmitted from the boundary element model 31 in accordance with displacement of that nodal point 36. The sound pressure transmitted from each nodal point 36 of the boundary element model 31 is represented by Formula 2 below using the acoustic transfer function calculated in step S18.

$$\begin{matrix}SP ( ω ) = [ ATV ( ω ) ] \cdot [ v ( ω ) ] \\ = [ {atv}_{B 1} ( ω ) , … , {atv}_{BN} ( ω ) ] \cdot [ {v}_{{BG}_{1}} ( ω ) , … , {v}_{{BG}_{N}} ( ω ) ] \\ = {atv}_{B 1} ( ω ) {v}_{{BG}_{1}} ( ω ) + … + {atv}_{BN} ( ω ) {v}_{{BG}_{N}} ( ω ) .\end{matrix} \qquad [ Formula 2 ]$$

Then, the control device 11 substitutes Formula 1, which is a relational formula that correlates each nodal point 36 of the boundary element model 31 with each nodal point 35 of the finite element model 27, into Formula 2, which is a relational formula that correlates each nodal point 36 of the boundary element model 31 with the sound pressure transmitted from that nodal point 36 to the observation point. The control device 11 then derives a calculation formula for the sound pressure transmitted from each nodal point 35 of the finite element model 27 to the observation point as indicated by Formula 3 below,

$$\begin{matrix}SP ( ω ) = {atv}_{B 1} ( ω ) {v}_{{BG}_{1}} ( ω ) + … + {atv}_{BN} ( ω ) {v}_{{BG}_{N}} ( ω ) \\ = {atv}_{B 1} ( ω ) ( {α}_{11} {v}_{{FG}_{11}} + {α}_{12} {v}_{{FG}_{12}} + {α}_{13} {v}_{{FG}_{13}} ) + … + \\ {atv}_{BN} ( ω ) ( {α}_{N 1} {v}_{{FG}_{N 1}} + {α}_{N 2} {v}_{{FG}_{N 2}} + {α}_{N 3} {v}_{{FG}_{N 3}} ) .\end{matrix} \qquad [ Formula 3 ]$$

In the embodiment, on the surface of the optimization model 43, each nodal point 35 of the finite element model 27 is disposed to be superimposed on each nodal point 42 of the shell model 39. Accordingly, the control device 11 incorporates the rate of displacement of each nodal point 42 of the shell model 39 calculated in step S17 into the calculation formula for the sound pressure. The control device 11 then derives a calculation formula for the sound pressure transmitted from the surface of the optimization model 43 to the observation point (step S19). In this respect, the control device 11 may be considered to include a sound pressure calculation section 47 that calculates the sound pressure transmitted from the optimization model 43 to the observation point.

Subsequently, the control device 11 reads out from the disk device 15 the specifications data 44 on the optimization model 43 generated in step S15. The control device 11 then sets the distance by which each plate element 38 of the shell model 39 is spaced away from the inner surface of the finite element model 27 in a direction perpendicular to the plane of that plate element 38 in the read optimization model 43, as the thickness of each region of the optimization model 43. The control device 11 further calculates a weight of the optimization model 43 on the basis of the thickness of each region of the set optimization model 43, and temporarily stores the calculated weight of the optimization model 43 in the RAM 20 as Wold (step S20).

Then, the control device 11 executes a sensitivity analysis, in which it is analyzed how much each design variable defining the behavior of the optimization model 43 affects the weight of the optimization model 43 when each nodal point 42 of the shell model 39 disposed on the surface of the optimization model 43 is displaced in a direction orthogonal to the plane of the plate elements 38 of the shell model 39 (step S21). In the embodiment, in optimizing the weight of the optimization model 43, the control device 11 causes no displacement of nodal points 42a, of nodal points 42 and 42a of the shell model 39, which are positioned on an outer edge 39a defining the contour shape of the shell model 39. That is, the nodal points 42a are excluded from design variables defining the behavior of the optimization model 43.

Subsequently, the control device 11 reads out from the ROM 19 an optimization algorithm for optimizing the weight of the optimization model 43, and incorporates the analysis results of the sensitivity analysis executed in step S21 into the read optimization algorithm. The control device 11 then calculates an optimum solution, which indicates the amount of displacement to be caused in order to optimize the weight of the optimization model 43, for each nodal point 42 of the shell model 39 positioned on the surface of the optimization model 43 (step S22). In the embodiment, the control device 11 calculates, for a part of the large number of plate elements 38 forming the shell model 39, an optimum solution that displaces the three nodal points 42 which serve as the vertexes of the plate elements 38 in a direction of reducing the thickness of the optimization model 43.

Then, as an optimization model modification step, the control device 11 generates a shape modified model 48 (see FIG. 6), which is obtained by displacing the nodal points 42 of the shell model 39 positioned on the surface of the optimization model 43 to modify the shape of the optimization model 43, on the basis of the optimum solution calculated in step S22. The control device 11 then causes the disk device 15 to store specifications data 49 on the generated shape modified model 48 (step S23). In this respect, the control device 11 may be considered to include an optimization model modification section 50 which serves as an optimization model modification unit that displaces the nodal points 42 of the shell model 39 to modify the shape of the optimization model 43 so as to optimize the weight of the optimization model 43.

Subsequently, the control device 11 reads out from the disk device 15 the specifications data 49 on the shape modified model 48 generated in step S23. The control device 11 then calculates the rate of displacement at which each nodal point 42 of the shell model 39 positioned on the surface of the read shape modified model 48 is displaced in accordance with the excitation force set in step S16 (step S24). The shape modified model 48 has been modified compared to the optimization model 43 in thickness of each region in accordance with the displacement of the nodal points 42 of the shell model 39. Therefore, the rate of displacement of each nodal point 42 of the shell model 39 in the shape modified model 48 is different from the rate of displacement of each nodal point 42 of the shell model 39 in the optimization model 43 derived in step S17.

Then, the control device 11 incorporates the rate of displacement of each nodal point 42 of the shell model 39 in the shape modified model 48 calculated in step S24 into the calculation formula for the sound pressure transmitted from the surface of the optimization model 43 to the observation point derived in step S19. The control device 11 then derives a calculation formula for the sound pressure transmitted from the surface of the shape modified model 48 to the observation point (step S25). In the embodiment, the control device 11 recursively uses the acoustic transfer function calculated in step S18 in the course of deriving a calculation formula for the sound pressure transmitted from the shape modified model 48 to the observation point in step S25.

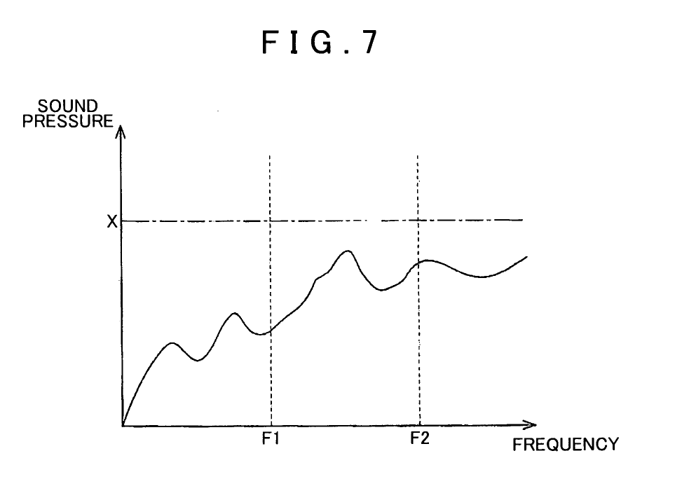

Subsequently, the control device 11 determines whether or not the acoustic characteristics of the shape modified model 48 generated in step S23 satisfy a preset restrictive condition on the basis of the calculation formula for the sound pressure derived in step S25 (step S26). Specifically, the control device 11 first reads out from the RAM 20 the calculation formula for the sound pressure transmitted from the surface of the shape modified model 48 to the observation point, and outputs a graph corresponding to the read calculation formula to the output device 13 for display (see FIG. 7). Next, the control device 11 determines whether or not the sound pressure in the frequency band set in step S16 (in the embodiment, between a first frequency F1 and a second frequency F2) is equal to or less than a threshold X preset as the restrictive condition in the graph output to the output device 13.

In the case where the determination result in step S26 is negative (that is, the sound pressure is not equal to or less than the threshold X), the control device 11 determines that the sound pressure transmitted from the surface of the shape modified model 48 to the observation point is not appropriate. The control device 11 then returns to step S21 to execute the processes in steps S21 to S25 again in order to further modify the shape of the shape modified model 48 so as to improve the acoustic characteristics of the shape modified model 48.

On the other hand, in the case where the determination result in step S26 is positive (that is, the sound pressure is equal to or less than the threshold X), the control device 11 determines that the sound pressure transmitted from the surface of the shape modified model 48 to the observation point is appropriate. The control device 11 then proceeds to step S27.

Then, in step S27, the control device 11 sets the distance by which each plate element 38 of the shell model 39 positioned on the surface of the shape modified model 48 is spaced away from the inner surface of the finite element model 27 in a direction perpendicular to the plane of that plate element 38, as the thickness of each region of the shape modified model 48. The control device 11 further calculates a weight of the shape modified model 48 on the basis of the set thickness of each region of the shape modified model 48, and temporarily stores the calculated weight of the shape modified model 48 in the RAM 20 as Wnew.

In the shape modified model 48, the nodal points 42 which serve as the vertexes of the plate elements 38 of the shell model 39 have been displaced in a direction orthogonal to the plane of the plate elements 38. Therefore, the thickness of each region of the shape modified model 48 is different from the thickness of each region of the optimization model 43 generated in step S15. Thus, the weight Wnew of the shape modified model 48 calculated in step S27 is varied from the weight Wold of the optimization model 43 calculated in step S20.

Accordingly, as a determination step, the control device 11 determines whether or not the weight of the shape modified model 48, in which the nodal points 42 of the shell model 39 have been displaced, has been optimized (step S28). Specifically, the control device 11 calculates an absolute value of the difference between the weight Wold of the optimization model 43 calculated in step S20 and the weight Wnew of the shape modified model 48 calculated in step S27 (that is, |Wold−Wnew|). The control device 11 then determines whether or not the calculated absolute value of the difference between the weights is less than a predetermined threshold preset as a determination criterion for determining whether or not the weight of the shape modified model 48 has been optimized.

In the case where the determination result in step S28 is negative (that is, the absolute value of the difference between the weights is not less than the predetermined threshold), the control device 11 determines that the weight of the shape modified model 48 has not been sufficiently reduced, and overwrites the weight Wold in the RAM 20 with the current weight Wnew of the shape modified model 48 (step S29). Thereafter, the control device 11 returns to step S21 to repeat the processes in steps S21 to S28 in order to further optimize the weight of the shape modified model 48.

On the other hand, in the case where the determination result in step S28 is positive (that is, the absolute value of the difference between the weights is less than the predetermined threshold), the control device 11 determines that the weight of the shape modified model 48 has been converged to a sufficiently reduced value, and determines that optimization of the weight of the shape modified model 48 has been completed. The control device 11 then causes the disk device 15 to store the current specifications data 49 on the shape modified model 48 (step S30), and thereafter terminates the weight optimization process routine.

Thus, the embodiment can provide the following effects.

(1) In modifying the shape of the optimization model 43, the control device 11 displaces, for a part of the large number of plate elements 38 forming the shell model 39, the three nodal points 42 which serve as the vertexes of the plate elements 38 in a direction of reducing the thickness of the optimization model 43. Therefore, it is possible to determine through analysis an optimum structural configuration of the shape modified model 48 while suppressing an increase in weight of the shape modified model 48.

(2) In optimizing the weight of the optimization model 43, the control device 11 causes no displacement of the nodal points 42a, of the nodal points 42 and 42a of the shell model 39, which are positioned on the outer edge 39a defining the contour shape of the shell model 39. That is, the nodal points 42a are excluded from design variables defining the behavior of the optimization model 43. Further, the number of the nodal points 42, of the nodal points 42 and 42a of the shell model 39, which are not positioned on the outer edge 39a defining the contour shape of the shell model 39 is smaller than the number of the plate elements 38 of the shell model 39. Thus, the processing load imposed on the CPU 18 in optimizing the weight of the shape modified model 48 is reduced compared to a case where all the nodal points 42 and 42a of the shell model 39 are used as design variables and a case where the plate elements 38 of the shell model 39 are used as design variables. Therefore, it is possible to determine through analysis an optimum structural configuration of the shape modified model 48 quickly and easily.

(3) The control device 11 compares the weight of the optimization model 43 before displacing the nodal points 42 of the shell model 39 with the weight of the shape modified model 48 after displacing the nodal points 42 of the shell model 39. Then, when the absolute value of the difference between the respective weights of the models 39 and 48 becomes less than the predetermined threshold set in advance, the control device 11 can determine that the weight of the shape modified model 48 has been converged to a sufficiently reduced value, and can determine that optimization of the weight of the shape modified model 48 has been completed.

(4) The control device 11 generates the optimization model 43 in which the shell model 39 is disposed to be superimposed on the surface of the finite element model 27, and displaces the nodal points 42 of the shell model 39 so as to reduce the weight of the optimization model 43. That is, the control device 11 uses only the nodal points 42 of the shell model 39 which are positioned on the surface of the finite element model 27 as design variables, and therefore the number of design variables is smaller than that in the case where all the nodal points 35 of the finite element model 27 are used as design variables. Thus, the processing load imposed on the CPU 18 in optimizing the weight of the shape modified model 48 is reduced, which makes it possible to determine through analysis an optimum structural configuration of the shape modified model 48 quickly and easily.

(5) In the course of optimizing the weight of the optimization model 43, the control device 11 determines whether or not the acoustic characteristics of the shape modified model 48 satisfy a predetermined restrictive condition. In this case, the control device 11 analyzes the acoustic characteristics of the shape modified model 48 while recursively utilizing an acoustic transfer function. Thus, the control device 11 can analyze the shape of the shape modified model 48 with an optimized weight reliably in a short time without imposing an excessive processing load.

The above embodiment may be modified as follows.
In the embodiment, the control device 11 may use the nodal points 42a which are positioned on the outer edge 39a defining the contour shape of the shell model 39 as design variables for optimizing the weight of the shape modified model 48.
In the embodiment, the control device 11 may integrate the sound pressure in the frequency direction within the frequency band to be analyzed in a graph indicating the calculation formula for the sound pressure transmitted from the surface of the shape modified model 48 to the observation point, and may determine whether or not the acoustic characteristics of the shape modified model 48 satisfy a restrictive condition on the basis of whether or not the value obtained as a result of the integration exceeds a predetermined threshold.
In the embodiment, the control device 11 may displace the nodal points 42 of the shell model 39 disposed on the surface of the optimization model 43 in a direction orthogonal to the plane of the plate elements 38 of the shell model 39 so as to optimize the acoustic characteristics of the optimization model 43. In this case, it is desirable that the control device 11 should generate a shape modified model 48 in which the nodal points 42 of the shell model 39 have been displaced, and determine whether or not the weight of the generated shape modified model 48 satisfies a restrictive condition set in advance.
In the embodiment, the control device 11 may be configured to displace, for all the plate elements 38 forming the shell model 39, the three nodal points 42 which serve as the vertexes of the plate elements 38 in a direction of reducing the thickness of the optimization model 43.
In the embodiment, the control device 11 may be configured to reduce the thickness of the optimization model 43 at one or two nodal points 42, of the three nodal points 42 which serve as the vertexes of the plate elements 38 forming the shell model 39, and not to displace the other nodal point(s) 42, or may be configured to reduce the thickness of the optimization model 43 at one or two nodal points 42 and to displace the other nodal point(s) 42 in a direction of increasing the thickness of the optimization model 43. That is, the control device 11 may be configured in any way as long as at least one nodal point 42, of the three nodal points 42 which serve as the vertexes of the plate elements 38 forming the shell model 39, is displaced in a direction of reducing the thickness of the optimization model 43 to reduce the weight of the optimization model 43.
In the embodiment, the control device 11 may displace the nodal points 42 of the shell model 39 disposed on the surface of the optimization model 43 in an oblique direction with respect to the plane of the plate elements 38 of the shell model 39.
In the embodiment, the control device 11 may calculate an acoustic transfer function each time the shape of the shape modified model 48 is modified, by reflecting variations in relative positional relationship between the observation point at which the sound pressure transmitted from the shape modified model 48 is observed and each nodal point 42 of the shell model 39 positioned on the surface of the shape modified model 48,
In the embodiment, the shape of the plate elements 38 of the shell model 39 is not limited to a triangular shape, and may be any polygonal shape (such as a quadrangular shape and a hexagonal shape, for example).
In the embodiment, the subject to be analyzed is not limited to the transfer case 25, and may be any design model having a three-dimensional shape.

What is claimed is:

1. An optimization model analysis apparatus comprising:
a finite element model generation unit that generates on the basis of a structural configuration of a design model having a three-dimensional shape a finite element model for analyzing acoustic characteristics of the design model by a finite element method;
a shell model generation unit that generates a shell model by dividing a surface of the finite element model into a plurality of plate elements having a polygonal shape;
an optimization model generation unit that superimposes the shell model on the surface of the finite element model to generate an optimization model; and
an optimization model modification unit that displaces nodal points which serve as vertexes of the plate elements in a direction intersecting a plane of the plate elements by displacing at least one of the nodal points in a direction of reducing a thickness of the optimization model.

2. The optimization model analysis apparatus according to claim 1, wherein
the optimization model modification unit causes no displacement of a nodal point, of the nodal points, which is positioned on an outer edge defining a contour shape of the shell model.

3. The optimization model analysis apparatus according to claim 1, further comprising:
a determination unit that determines whether or not a weight of the optimization model in which the nodal points have been displaced by the optimization model modification unit has been optimized, wherein
the optimization model modification unit displaces the nodal points in a direction of reducing the weight of the optimization model in the case where a result of determination performed by the determination unit is negative.

4. An optimization model analysis method comprising the steps of:
generating on the basis of a structural configuration of a design model having a three-dimensional shape a finite element model for analyzing acoustic characteristics of the design model by a finite element method;
generating a shell model by dividing a surface of the finite element model into a plurality of plate elements;
superimposing the shell model on the surface of the finite element model to generate an optimization model; and
displacing nodal points which serve as vertexes of the plate elements in a direction intersecting a plane of the plate elements by displacing at least one of the nodal points in a direction of reducing a thickness of the optimization model.

5. An optimization model analysis program that causes an optimization model analysis apparatus to operate, the apparatus including a control unit that controls procedures of a process for optimizing a design model having a three-dimensional shape, the program causing the control unit to function as:
a finite element model generation unit that generates on the basis of a structural configuration of the design model a finite element model for analyzing acoustic characteristics of the design model by a finite element method;
a shell model generation unit that generates a shell model by dividing a surface of the finite element model into a plurality of plate elements;
an optimization model generation unit that superimposes the shell model on the surface of the finite element model to generate an optimization model; and
an optimization model modification unit that displaces nodal points which serve as vertexes of the plate elements in a direction intersecting a plane of the plate elements by displacing at least one of the nodal points in a direction of reducing a thickness of the optimization model.
